(19) United States
(12) Patent Application Publication
(10) Pub. No.: US 2008/0088220 A1
(43) Pub. Date: Apr. 17, 2008

(54) ELECTRON EMISSION DEVICE

(76) Inventor: Ki-Hyun Noh, Yongin-si (KR)

Correspondence Address: CHRISTIE, PARKER & HALE, LLP, PO BOX 7068, PASADENA, CA, 91109-7068, US

(21) Appl. No.: 11/855,041

(22) Filed: Sep. 13, 2007

(30) Foreign Application Priority Data
Oct. 16, 2006 (KR) 10-2006-0100467

(51) Int. Cl. H01J 19/06

(52) U.S. Cl. 313/346 R

(57) ABSTRACT

An electron emission device includes a substrate, a cathode electrode that is formed on the substrate, and one or more electron emission regions that are electrically connected to the cathode electrode. Pixel regions correspond to cross over areas of the cathode electrode and gate electrodes. The cathode electrode includes a main electrode including one or more openings corresponding to the pixel regions and two or more separated portions on two sides of the openings and a resistive layer electrically connected to the electron emission region. The separated portions have substantially identical widths. The electron emission regions are located inside the openings. Equal widths of the separated portions cause a uniform voltage on two sides of the electron emission regions and therefore a more uniform emission of electrons.

### CROSS-REFERENCE TO RELATED APPLICATION

This application claims priority to and the benefit of Korean Patent Application No. 10-2006-0100467 filed on Oct. 16, 2006 in the Korean Intellectual Property Office, the entire content of which is incorporated herein by reference.

### BACKGROUND OF THE INVENTION

1. Field of the Invention

The present invention relates to an electron emission device and, more particularly, to an electron emission device that is designed to improve emission uniformity of each pixel region.

2. Description of Related Art

Generally, electron emission elements are classified into those using hot cathodes as an electron emission source, and those using cold cathodes as the electron emission source.

There are several types of cold cathode electron emission elements, including a field emitter array (FEA) type, a metal-insulator-metal (MIM) type, a metal-insulator-semiconductor (MIS) type, and a surface conduction emitter (SCE) type.

The FEA type electron emission element includes cathode and gate electrodes and electron emission regions. An electron emission region is formed of a material having a low work function or a high aspect ratio, such as a carbonaceous material or a nanometer-size material that can effectively emit electrons in a vacuum environment under the influence of an electric field.

A plurality of electron emission elements that are arranged in an array on a first substrate form an electron emission unit. A light emission unit having a phosphor layer and an anode electrode is formed on a surface of a second substrate opposite to the first substrate. The combination of the electron emission unit and the light emission unit forms a light emission device.

### SUMMARY OF THE INVENTION

In an electron emission device, an unstable driving voltage may be applied to electrodes that are connected to electron emission regions (hereinafter referred to as “first electrodes”) to apply an electron emission current to the electron emission regions. Further, voltages applied to different electron emission regions may be different due to the voltage drop along or at the first electrodes. Due to the voltage difference, the emission characteristic between different electron emission regions becomes non-uniform and thus the uniformity of light emission from a pixel region including the electron emission regions is deteriorated.

Therefore, in order to improve the emission uniformity, a structure where the cathode electrode includes a main electrode, isolation electrodes on which the electron emission regions are located, and a resistive layer electrically connecting the main electrode to the isolation electrodes is provided by the embodiments of the present invention.

When intensities of the voltages applied to the isolation electrodes are different from one another, the emission uniformity of the electron emission regions may deteriorate. Embodiments of the present invention provide an electron emission device having an improved cathode electrode that can improve emission uniformity among the electron emission regions located on the same isolation electrode.

In an exemplary embodiment of the present invention, an electron emission device includes a substrate, a cathode electrode that is formed on the substrate, and one or more electron emission regions that are electrically connected to the cathode electrode. The cathode electrode includes a main electrode and a resistive layer. The main electrode is provided with one or more openings corresponding to pixel regions defined on the substrate and has two or more separated portions that are located between the openings and on either side of the openings. The separated portions have identical widths. The resistive layer is electrically connected to the electron emission region.

The resistive layer may contact the main electrode and the electron emission region may be formed on the resistive layer.

The resistive layer may be formed on the main electrode while covering the opening.

The resistive layer may be formed with a plurality of sections that are individually formed on the respective openings.

Alternatively, the resistive layer may be formed with a plurality of sections that correspond to pixel regions in the opening.

Alternatively, the resistive layer may be formed with a plurality of sections that correspond to the electron emission regions.

The cathode electrode may further include one or more isolation electrodes that are located in the opening of the main electrode and spaced apart from the main electrode with the electron emission regions being located on the isolation electrodes. The resistive layer may electrically connect the main electrode to the isolation electrodes.

The resistive layer may be provided with one or more openings for exposing the electron emission regions.

The resistive layer may have a predetermined width and may extend along a length of the main electrode on two sides of the opening of the main electrode and between the openings when more than one opening is provided. The resistive layer may have a plurality of sections corresponding to the pixel regions.

The resistive layer may be formed with a plurality of sections corresponding to the isolation layers.

The electron emission region may include a material selected from the group consisting of carbon nanotubes, graphite, graphite nanofibers, diamonds, diamond-like carbon, fullerene C₆₀, silicon nanowires, and a combination thereof.

One embodiment of the present invention provides a light emission device including a first substrate including an electron emission unit and a second substrate including a light emission unit. The second substrate is located opposite the first substrate and set apart by spacers located between the first substrate and the second substrate. The first substrate and the second substrate may be sealed together to form a vacuum chamber. The electron emission unit includes a cathode electrode extending along a first direction on the first substrate, a first insulating layer located over the first substrate covering the cathode electrode, a gate electrode extending along a second direction perpendicular to the first direction over the first insulating layer, a second insulating layer covering the gate electrode and the first insulating layer, and a focusing electrode covering the second insulating layer and including focusing openings in a pixel region. The pixel region corresponds to a crossover area of the gate electrode and the cathode electrode. The light emission unit includes a phosphor layer formed along the first direction on the second substrate in the pixel region and an anode layer formed on the phosphor layer. The cathode electrode includes a main electrode having main electrode openings in the pixel region, a resistive layer located over the main electrode and electrically connected to the main electrode, and electron emission regions within the main electrode openings and electrically connected to the resistive layer. The resistive layer includes separated portions extending along the first direction between the main electrode openings. The separated portions have substantially equal widths along the second direction. The resistive layer may include resistive layer openings located within the main electrode openings. The cathode electrode may further include isolation electrodes located on the first substrate within the main electrode openings. The electron emission regions may be located on the isolation electrodes and electrically connected with the isolation electrodes. The resistive layer may overlaps the isolation electrodes to be electrically connected with the isolation electrodes.

One embodiment of present invention provides a method for forming an electron emission unit. The method includes forming a substrate, forming a cathode electrode extending along a first direction on the substrate, forming a first insulating layer over the second substrate covering the cathode electrode, forming a gate electrode extending along a second direction perpendicular to the first direction over the first insulating layer, a pixel region corresponding to a crossover area of the gate electrode and the cathode electrode. Forming the cathode electrode includes forming a main electrode having main electrode openings in the pixel region, forming a resistive layer located over the main electrode and electrically connected to the main electrode, and forming electron emission regions within the main electrode openings and electrically connected to the resistive layer. The resistive layer includes separated portions extending along the first direction between the main electrode openings and having substantially equal widths along the second direction. The method may also include forming resistive layer openings in the resistive layer that are located within the main electrode openings, forming isolation electrodes on the second substrate within the main electrode openings, forming the electron emission regions on the isolation electrodes and electrically connecting the electron emission regions with the isolation electrodes, and overlapping and electrically connecting the resistive layer with the isolation electrodes.

### BRIEF DESCRIPTION OF THE DRAWINGS

FIG. 1 is a fragmentary schematic exploded perspective view of a light emission device using an electron emission device according to an exemplary embodiment of the present invention;

FIG. 2 is a partial sectional view of the light emission device of FIG. 1;

FIG. 3 is a plan view of a portion around a cathode electrode of an electron emission device according to an exemplary embodiment of the present invention; and

FIG. 4 is a plan view of a portion around a cathode electrode of an electron emission device according to another exemplary embodiment of the present invention.

### DETAILED DESCRIPTION

In embodiments of the present invention, a light emission device includes all devices that can emit light. Therefore, any display that can transmit information by displaying symbols, letters, numbers, and images may be considered a light emission device. In addition, the light emission device may be used as a light source for emitting light to a passive type display panel.

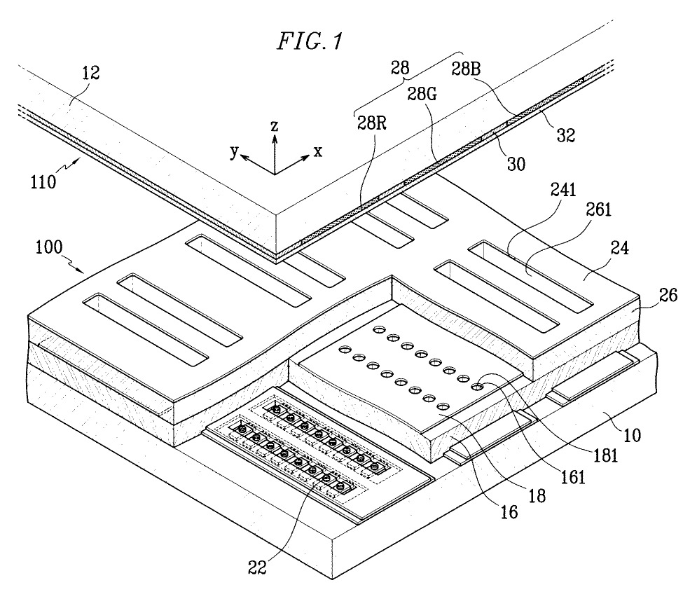

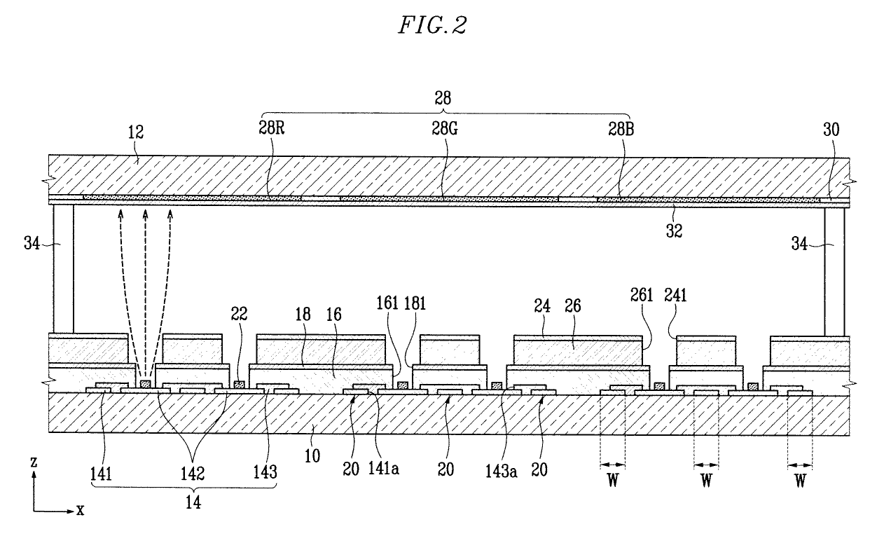

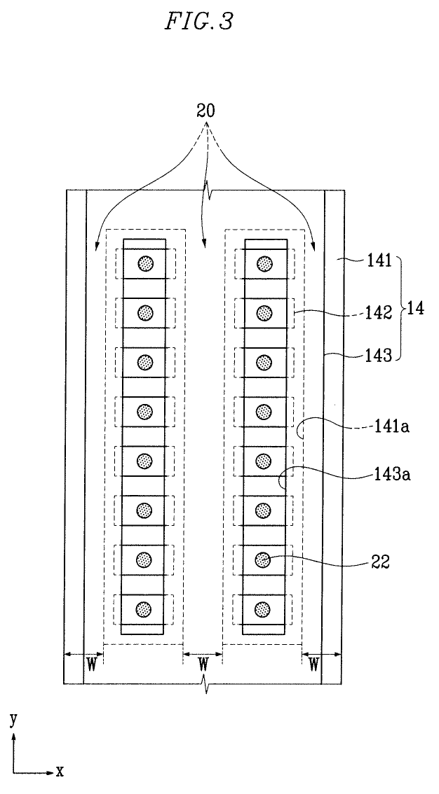

FIGS. 1 and 2 are respectively fragmentary schematic exploded perspective and partial sectional views of a light emission device using an electron emission device according to an exemplary embodiment of the present invention. FIG. 3 is a plan view of a portion around a cathode electrode of the electron emission device shown in FIGS. 1 and 2.

Referring to FIGS. 1 through 3, a light emission device includes first and second substrates 10 and 12 facing each other in parallel and spaced apart from each other. A distance between the first and second substrates 10 and 12 may be predetermined. A sealing member (not shown) is provided at peripheries of the first and second substrates 10 and 12 to seal them together, thereby forming a vessel. The interior of the vessel is exhausted and kept at a vacuum of about 10⁻⁶ Torr.

An electron emission unit 100 on which electron emission regions 22 are arranged is provided on a surface of the first substrate 10 that is opposite to the second substrate 12. Electron emission regions 22 may be arranged in an array. A light emission unit 110 is provided on a surface of the second substrate 12 opposite to the first substrate 10.

Describing the electron emission unit 100 in more detail, the electron emission unit 100 includes a plurality of cathode electrodes 14, an insulation layer 16, and a plurality of gate electrodes 18. The cathode electrodes 14 are formed on the first substrate 10 and arranged in a striped pattern extending in a first direction (y-axis direction in the drawings). The insulation layer 16 is formed over the surface of the first substrate while covering the cathode electrodes 14. The gate electrodes 18 are formed on the first insulation layer 16 and arranged in a striped pattern extending in a second direction (x-axis direction in the drawings) intersecting the direction of the cathode electrodes 14 at right angles.

A pixel region is defined as an intersection region of directions of the cathode and gate electrodes 14 and 18, where the two electrodes cross over. In one example, a pixel may include three pixel regions corresponding to red, green and blue colors. In the embodiment shown in FIGS. 1, 2 and 3, each of the cathode electrodes 14 includes a main electrode 141, isolation electrodes 142, and a resistive layer 143. The main electrode 141 is provided with one or more openings 141a in each of the pixel regions. The isolation electrodes 142 are located in the openings 141a and are spaced apart from the main electrode 141 (see FIG. 3). The resistive layer 143 electrically connects the isolation electrode 142 to the main electrode 141 on two sides of the isolation electrode 142 (see FIG. 2).

The Openings 141a extend along a length of the main electrode 141 (y-axis direction) and divided the main electrode 141 along its width (x-axis direction). One or more of the openings 141a are formed along a width direction (x-axis direction) of the main electrode 141. Portions of the main electrode 141 in the width direction of the main electrode 141, which are separated by the openings 141a, are called separated portions 20. Widths W (along the x-axis) of the separated portions 20 are substantially identical to one another. The drawings show an embodiment where two openings 141a are formed in the main electrode 141. Consequently, three separated portions 20 having substantially identical widths W are formed between the openings 141a and on either side of the openings 141a. In other embodiments, a different number of openings may be formed in the main electrode resulting in a different number of separated portions corresponding to each main electrode.

The isolation electrodes 142 are arranged in the openings 141a along a length (y-axis direction) of the main electrode 141 (see FIG. 3). The electron emission regions 22 are formed on the isolation electrodes 142. The resistive layer 143 is located along the length direction (y-axis direction) of the main electrode 141 and on two sides of the isolation electrodes 142. The two sides of the isolation electrode 142 where the resistive layer is formed are along the length direction (y-axis direction) of the isolation electrodes 142.

The resistive layer 143 may be formed of a material having a resistivity ranging from 10,000Ωcm to 100,000Ωcm. For example, the resistive layer may be formed of amorphous silicon doped with p or n-type ions.

The resistive layer 143 extends along the length of the main electrode 141 and may have a predetermined width (along the x-axis direction). The resistive layer 143 is formed to partly cover top surfaces of the main and isolation electrodes 141 and 142 to reduce the contact resistance between the main electrodes 141 and the isolation electrodes 142. The resistive layer 143 may have a thickness of about 2,000 Å.

The drawings depict an exemplary embodiment, where the resistive layer 143 extends along the length of the main electrode 141 and is provided with openings 143a partly exposing the isolation electrodes 142. However, the present invention is not limited to the exemplary embodiment shown. That is, the resistive layer 143 may be formed in a striped pattern having resistive lines provided between the isolation electrodes 142. Alternatively, the resistive layer 143 may have a plurality of sections that are individually formed to correspond to the electron emission regions 22 or the pixel regions.

A driving voltage, from an external driving circuit unit (not shown), is applied to the main electrode 141. The driving voltage applied to the main electrode 141 is transmitted to the isolation electrodes 142 through the resistive layer 143. Resistance between the main electrode 141 and the isolation electrodes 142 may be controlled by adjusting a distance between the main electrode 141 and the isolation electrodes 142.

The electron emission regions 22 may be formed of a material, which emits electrons when an electric field is applied thereto under a vacuum atmosphere, such as a carbonaceous material or a nanometer-sized material. For example, the electron emission regions 22 may be formed of carbon nanotubes, graphite, graphite nanofibers, diamonds, diamond-like carbon, fullerene C₆₀, silicon nanowires, or a combination thereof.

Alternatively, the electron emission regions 22 may be formed in a tip structure formed of a Mo-based or Si-based material.

Openings 161 and openings 181, which correspond to the electron emission regions 22, are respectively formed in the first insulation layer 16 and the gate electrode 18 to expose the electron emission regions 22 on the first substrate 10.

A focusing electrode 24 may be formed above the gate electrodes 18 and the first insulation layer 16. A second insulation layer 26 is located under the focusing electrode 24 to insulate the gate electrodes 18 from the focusing electrode 24. Openings 241 and openings 261 through which electron beams pass are respectively formed in the focusing electrode 24 and the second insulation layer 26.

Each of the openings 241 of the focusing electrode 24 may correspond to one of the electrode emission regions 22 to cause the electrons emitted from the one corresponding electron emission region 22 to converge into a beam. Alternatively, each of the openings 241 of the focusing electrode 24 may correspond to one of the pixel regions to cause the electrons emitted from all of the electron emission regions 22 of the one pixel region to converge together into a beam. In addition, as shown in FIG. 1, two or more of the openings 241 of the focusing electrode 24 may correspond to one pixel region. Then, each of the two openings 241 causes the electrons emitted from the electron emission regions 22 that are arranged corresponding to that particular opening 241 to converge together to form a beam. For example, in FIG. 1, the electrons emitted from the electron emission regions 22 that are arranged in a line along the length of the main electrode (y-axis direction) correspond to one opening 241 and are converged by the focusing electrode 24.

Describing the light emission unit 110 in more detail, the phosphor layers 28 such as red, green, and blue phosphor layers 28R, 28G, and 28B are formed on a surface of the second substrate 12. A black layer 30 for enhancing the screen contrast is formed between the phosphor layers 28R, 28G and 28B. The phosphor layers 28R, 28G and 28B may be arranged to correspond to the pixel regions.

The anode electrode 32 that is a metal layer formed of, for example, aluminum is formed on the phosphor and black layers 28 and 30. The anode electrode 32 can place the phosphor layers 28 in a high potential state by receiving a voltage for accelerating the electron beams. The anode electrode 32 can also enhance the screen luminance by reflecting the visible light, which is emitted from the phosphor layer 28 toward the first substrate 10, back toward the second substrate 12.

Alternatively, the anode electrode may be a transparent conductive layer formed of, for example, indium tin oxide (ITO). In this case, the anode electrode may be located between the second substrate 12 and the phosphor layers 28. Alternatively, the anode electrode may include both a transparent conductive layer and a metal layer.

Disposed between the first and second substrates 10 and 12 are spacers 34 (see FIG. 2) for enduring compression forces applied to the vacuum vessel and maintaining a uniform gap between the first and second substrates 10 and 12. In order not to interfere with the light emission of the phosphor layers 28, the spacers 34 are located to correspond to the black layer 30.

The above-described light emission device is driven when predetermined driving voltages are applied to the cathode, gate, focusing, and anode electrodes 14, 18, 24, and 32.

By way of example, a scan driving voltage is applied to one of the cathode and gate electrodes 14 and 18. The electrode receiving the scan driving voltage functions as a scan driving electrode. A data driving voltage is applied to the other of the cathode and gate electrodes 14 and 18. The electrode receiving the data driving voltage serves as a data driving electrode.

The focusing electrode 24 receives 0V or a negative direct current voltage of, for example, several volts to tens of volts. The anode electrode 32 receives a voltage required for accelerating the electron beams, for example, a positive direct current voltage (an anode voltage) of hundreds through thousands of volts.

Then, electric fields are formed around the electron emission regions 22 where a voltage difference between the cathode and gate electrodes 14 and 18 is equal to or higher than a threshold value. As a result, electrons are emitted from the electron emission regions 22. The emitted electrons are converged to a central portion of a bundle of electron beams while passing through the openings 241 of the focusing electrode 24. The emitted electrons, then, collide with the phosphor layer 28 of the corresponding pixel region by being attracted by the anode voltage applied to the anode electrode 32. Collision of the emitted electrons with the phosphor layer 28 excites the corresponding portion of the phosphor layer 28.

According to the present exemplary embodiment, since the separation portions 20 formed on two sides of each of the openings 141 a have identical widths W, intensity of the voltage along the separation portions 20 is uniform and thus a uniform voltage can be applied to the isolation electrodes 142 of the pixel region.

The electron emission device of the present exemplary embodiment can improve the light emission uniformity and the luminance uniformity as the uniformity of the electron emission from the electron emission regions 22 is improved.

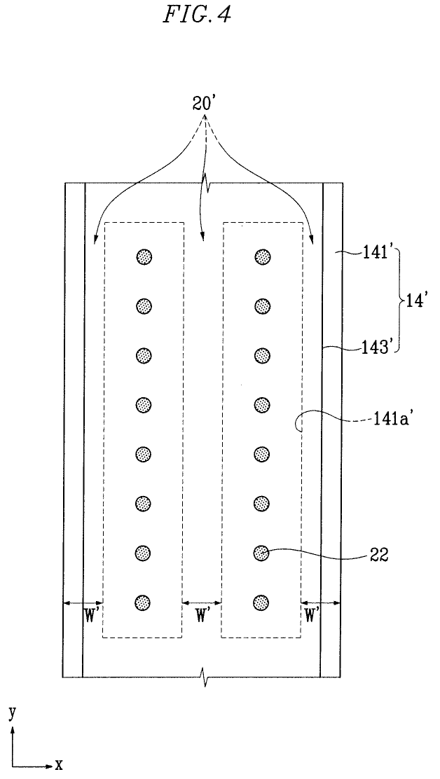

FIG. 4 is a plan view of a portion around a cathode electrode of an electron emission device according to another exemplary embodiment of the present invention.

Referring to FIG. 4, a cathode electrode 14′ includes a main electrode 141′ provided with one or more openings 141a′ corresponding to pixel regions and a resistive layer 143′ formed on the main electrode 141′ while covering the openings 141a′.

Like the foregoing exemplary embodiment of FIGS. 1, 2 and 3, one or more of the openings 141a′ are formed in the main electrode 141′. The one or more openings 141a′ extend partially along a length (y-axis direction) of the main electrode 141′ and divide the main electrode 141′ along its width direction (x-axis direction). As a result of the openings 141a′, separated portions 20′ each having a width W′ are formed on two sides of the openings 141a′. The separated portions 20′ have their width W′ along the x-axis and are formed on two sides along the y-axis of the openings 141a′. A structure of the main electrode 141′ is similar to that of the main electrode of the foregoing embodiment; a detailed description thereof will be omitted herein.

The resistive layer 143′ that is formed on the main electrode 141′ while covering the openings 141a′ of the main electrode 141′ partly covers top surfaces of the separated portions 20′ to reduce the contact resistance with the main electrode 141′. One or more electron emission regions 22 are arranged on the resistive layer 143′.

FIG. 4, illustrates an example where the resistive layer 143′ extends along a length of the main electrode 141′. However, the present invention is not limited to the example shown. That is, the resistive layer 143′ may be formed in a striped pattern with the stripes extending in a length or a width direction of the main electrode 141′ where the openings 141a′ is located. Alternatively, the resistive layer 143′ may have a plurality of sections that are individually formed to correspond to the electron emission regions 22 or the pixel regions.

Since other components of this exemplary embodiment are similar to those of the aforementioned exemplary embodiment, a detailed description thereof will be omitted herein.

As described above, in the electron emission device according to the embodiments of the present invention, the main electrode has separated portions having substantially identical widths. As a result, a uniform voltage can be applied to the electron emission regions within a pixel region and thus the emission property of the electron emission regions becomes uniform.

Therefore, in the light emission device having the electron emission device of the present invention, the light emission uniformity of the phosphor layers and the luminance uniformity of the pixels is improved, thereby improving the display quality.

Although exemplary embodiments of the present invention have been described, it should be understood that many variations and/or modifications of the basic inventive concept taught herein fall within the spirit and scope of the present invention, as defined by the appended claims and their equivalents.

What is claimed is:

1. An electron emission device comprising:
a substrate;
a cathode electrode located on the substrate; and
one or more electron emission regions electrically connected to the cathode electrode,
wherein the cathode electrode comprises:
a main electrode having one or more openings corresponding to a pixel region and two or more separated portions located on two sides of the one or more openings along a length of the cathode electrode, the two or more separated portions having substantially identical widths; and
a resistive layer electrically connected to the one or more electron emission regions.

2. The electron emission device of claim 1,
wherein the resistive layer contacts the main electrode, and
wherein the one or more electron emission regions are on the resistive layer.

3. The electron emission device of claim 1, wherein the resistive layer is located on the main electrode and covers the one or more openings.

4. The electron emission device of claim 3, wherein the resistive layer includes sections separately located on the one or more openings.

5. The electron emission device of claim 3, wherein the resistive layer includes sections corresponding to the pixel region in the openings.

6. The electron emission device of claim 3, wherein the resistive layer includes sections corresponding to the one or more electron emission regions.

7. The electron emission device of claim 1,
wherein the cathode electrode further comprises one or more isolation electrodes located in the one or more openings and spaced apart from the main electrode, the electron emission regions being located on the one or more isolation electrodes, and
wherein the resistive layer electrically connects the main electrode to the one or more isolation electrodes.

8. The electron emission device of claim 7, wherein the resistive layer is provided with one or more resistive layer openings for exposing the electron emission regions.

9. The electron emission device of claim 7, wherein the resistive layer has a predetermined width and extends along a length of the main electrode on two sides of the one or more openings.

10. The electron emission device of claim 7, wherein the resistive layer includes sections corresponding to the pixel region.

11. The electron emission device of claim 7, wherein the resistive layer includes sections corresponding to the one or more isolation layers.

12. The electron emission device of claim 7, wherein the one or more electron emission regions include a material selected from the group consisting of carbon nanotubes, graphite, graphite nanofibers, diamonds, diamond-like carbon, fullerene C₆₀, silicon nanowires, and a combination thereof.

13. The electron emission device of claim 1, wherein the one or more electron emission regions include a material selected from the group consisting of carbon nanotubes, graphite, graphite nanofibers, diamonds, diamond-like carbon, fullerene C₆₀, silicon nanowires, and a combination thereof.
